(19) United States
(12) Patent Application Publication
(10) Pub. No.: US 2024/0330764 A1
(43) Pub. Date: Oct. 3, 2024

(54) SYSTEMS AND METHODS FOR FORMAT-AGNOSTIC PUBLICATION OF MACHINE LEARNING MODEL

(71) Applicant: OPEN TEXT HOLDINGS, INC., Menlo Park, CA (US)

(72) Inventors: Abhishek Pattanaik, Hyderabad (IN); Thirumalesh Yenagandula, Hyderabad (IN); Mahima Khatri, Puppalaguda (IN)

(21) Appl. No.: 18/318,057

(22) Filed: May 16, 2023

(30) Foreign Application Priority Data
Apr. 3, 2023 (IN) 202341025308

(51) Int. Cl. G06N 20/00

(52) U.S. Cl. CPC G06N 20/00

(57) ABSTRACT

A system for format-agnostic publication of a machine learning model may receive, through an application programming interface (API), machine learning models that have been built, developed, and trained in disparate computing environments, validate and normalize these machine learning models, generate a docker image for each validated and standardized machine learning model, and publish the docker images to a docker registry. The docker images can then be deployed to a managed cluster such as an on-prem managed cluster operating in an enterprise computing environment and/or a managed hyperscale cluster operating in a cloud computing environment. This API-based machine learning model publication approach allows any analytics model developed and trained in any modeling environment be deployed to any managed cluster.

### TECHNICAL FIELD

This disclosure relates generally to analytics modeling management and publication. More particularly, this disclosure relates to systems, methods, and computer program products for application programming interface based machine learning model publication and management, useful for publishing machine learning models on the fly, including third-party machine learning models.

### BACKGROUND OF THE RELATED ART

Machine learning (ML) is a branch of artificial intelligence (AI) that focuses on the ability of computer systems to learn from data, identify patterns, and make decisions without preprogrammed rules. ML has many practical applications in today's world, for instance, virtual assistant, self-driving cars, stock price prediction, etc.

For a machine to learn how to perform a task, a ML model is needed. Generally, a ML model is built by a human in a model development environment, also referred to herein as modeling environment, and after training and testing, deployed to a production environment. AZURE Machine Learning Service, available from Microsoft Corporation, is an example of a service that provides a cloud-based computing environment that a user can use to build, develop, train, test, and deploy ML models.

Generally, before a trained ML model can be deployed, the model is packaged into a software package. In the case of a ML model that was trained using the AZURE Machine Learning Service, the model is packaged as a container image. This packaging can be done using a computer program that performs operating-system-level virtualization (“containerization”). The container image includes the dependencies needed to run the trained ML model. The packaged ML model can then be deployed to AZURE-specific web services in the AZURE cloud computing environment.

The packaged ML model can also be deployed to other target computer systems, either on-premises or in the cloud. However, coding (e.g., in Python, C++, etc.) is required each time the ML model is to be published to a non-AZURE target (e.g., writing code to create an image configuration, writing code to create an image using the image configuration, writing code to define a deployment configuration for deploying, etc.). Manual coding is a time-consuming, tedious, and labor-intensive task and requires in-depth programming knowledge and knowledge of a target system to which the ML model is to be published.

### SUMMARY OF THE DISCLOSURE

The invention disclosed herein takes an application programming interface (API) based approach to ML model publication in which a ML model is developed and trained anywhere and published on the fly using an API provided by an ML model management (MLMM) system. The development and training of a ML model can be done through any suitable ML software packages, libraries, and platforms. The MLMM system takes a pre-trained ML model, builds a docker image, and posts the docker image to a docker registry (e.g., a container registry). The docket image is available via the API and can be deployed in a managed cluster of nodes that run containerized applications. The MLMM system handles all the building of the ML model and the deployment, tying together all the various open source software (OSS) and other code.

More specifically, in some embodiments, a method for an API-based ML model publication can comprise receiving, by an MLMM system having a processor and a non-transitory computer-readable medium through an API of the MLMM system, a request to publish a ML model trained using a third-party ML modeling application. The request contains a ML model package and an ML model schema for a ML model in the ML model package. The ML model package can be compressed or it can comprise a zip file. The ML model package can comprise at least one of a file, a directory, or assets needed to host the ML model as a service. The ML model schema may comprise a file in a JavaScript Object Notation (JSON) format. The JSON file can contain metadata describing the ML model.

In response to the API call from the client device, the MLMM system is operable to process the ML model package, obtain the ML model from the ML model package, validate the ML model, convert the ML model into a standard format, generate a docker image for the ML model in the standard format, and post, upload, or push the docker image to a docker registry. At this point, the ML model is considered published. The ML model published to the docker registry is available for deployment to a managed cluster. As a non-limiting example, the MLMM system can deploy the docker image corresponding to the ML model to a cloud-based managed cluster such as a KUBERNETES (K8s) cluster operating in a cloud computing environment or to an on-prem managed cluster operating in an enterprise computing environment.

In some embodiments, the API comprises an API wrapper which, prior to converting the ML model into the standard format, calls a model validation API for validating the ML model obtained from the machine learning model package. Responsive to the ML model being valid, the API wrapper calls a model conversion API to convert the ML model to the standard format and receive the ML model in the standard format. The API wrapper then calls an MLMM API with the ML model in the standard format to generate the docker image.

In some embodiments, validation of the ML model can comprise at least one of: checking whether the ML model is of a valid supported model type, verifying whether the ML model is packaged correctly based on the valid supported model type, determining whether the ML model is free of malware, determining whether the ML model package contains any unwarranted file or system call, and where the ML model package is a zip file, validating a file name of the zip file. Other validation methods may also be used.

In some embodiments, responsive to the ML model being invalid, the method may further comprise deleting the ML model from a temporary location in a file system of the MLMM system and/or generating an error code or message indicating that the ML model is invalid.

In some embodiments, the method may further comprise receiving requests to publish third-party ML models from disparate modeling applications (which can run in disparate computing environments) where the ML models were trained. In some embodiments, the disparate computing environments are operated and/or owned independently of one another. The third-party ML models (which can be in disparate formats) can be validated and/or converted to the standard format so that a docker image can be generated for each of the third-party ML models in the standard format using, for instance, a source-to-image toolkit called S21. The docker images corresponding to the converted ML models can then be posted, uploaded, or published to the docker registry for deployment to a managed cluster (in a cloud and/or on-prem).

Effectively, from the perspective of a data scientist or a member of a ML DevOps, a pre-trained analytics model is “published” to the MLMM system via a single API call. From the perspective of the MLMM system, the pre-trained analytics model is published once a docker image thereof is uploaded to, or otherwise stored in, the docker registry for deployment to a managed cluster (in the cloud and/or on-prem).

When compared to approaches taken by hyperscalers (which refers to large-scale cloud service providers that operate large-scale data centers), the API-based ML model publication approach disclosed herein has the following advantages:

Platforms supporting the approaches taken by hyperscalers (e.g., GOOGLE, AMAZON, AZURE, etc.) are tied to their own respective, proprietary managed cloud clusters, so there is no interoperability among these platforms. AZURE does have integration with GITHUB. However, the integration is format specific and does not support ML models trained using third-party software.

Contrastingly, the API-based ML model publication approach disclosed herein does not restrict data scientists to training ML models in an on-prem computing environment. Rather, data scientists can freely train, as per their convenience, ML models using any appropriate notebook (e.g., a JUPYTER based notebook, an OSS-based notebook, etc.) and upload that trained ML model, for instance, in the form of a zip file, for deployment to a K8s cluster. With a single click (which sends a request via an API call to publish a trained ML model to the MLMM system), the MLMM system programmatically automatically validates the incoming ML model, builds a docker file for the ML model in the standard format, generates a docker image, and publishes the docker image to the docker registry for deployment.

Accordingly, this API-based ML model publication decouples the training of a ML model from the actual publication (and subsequent deployment) of the ML model. Further, this API-based ML model publication allows any-to-any relationships in which any analytics model developed and trained in any modeling environment can be deployed to any managed cluster.

For instance, with the API-based ML model publication disclosed herein, a pre-trained ML model (e.g., trained using a ML library such as SCI-KIT LEARN “SKLEARN,” PYTORCH, TENSORFLOW, SPARK MLlib, etc.) can be deployed to an on-prem K8s cluster and/or managed K8s cluster through managed services (e.g., AZURE K8s Service (AKS), AMAZON Elastic K8s Service (EKS), GOOGLE K8s Engine (GKE), etc.) and run as a containerized application via an instance of the docker image. GOOGLE, AMAZON, AZURE, K8s, JUPYTER, SKLEARN, PYTORCH, TENSORFLOW, SPARK, MLlib, AKS, EKS, GKE, OSS, JSON, MLflow, S2I, and containerized applications are known to those skilled in the art and thus are not further described herein.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flow chart that illustrates an example of an application programming interface based machine learning model publication method according to some embodiments disclosed herein.

FIG. 2 depicts a diagrammatic representation of an example of a network computing environment where a machine learning model management system is part of an artificial intelligence and analytics platform according to some embodiments disclosed herein.

FIG. 3 depicts a diagrammatic representation of an example of a network computing environment having a machine learning model management system implementing an application programming interface based machine learning model publication method according to some embodiments disclosed herein.

FIG. 4 depicts a diagrammatic representation of an example of a machine learning model lifecycle, including application programming interface based machine learning model publication and deployment, according to some embodiments disclosed herein.

FIG. 5 depicts a diagrammatic representation of a user interface of machine learning modeling application.

FIG. 6 shows an example of an input schema for a machine learning model.

FIG. 7 is a sequence diagram that illustrates an example of an application programming interface based machine learning model publication method according to some embodiments disclosed herein

FIGS. 8A-8B depict diagrammatic representations of an example machine learning model management user interface before and after machine learning model deployment according to some embodiments disclosed herein.

FIG. 9 is an example of a machine learning model management document storing machine learning model details according to some embodiments disclosed herein.

FIG. 10 depicts a diagrammatic representation of an example user interface through which a deployed machine learning model can be called to make a prediction according to some embodiment disclosed herein.

FIG. 11 depicts a diagram that illustrates an example of format-agnostic publication of a machine learning model according to some embodiments disclosed herein.

FIG. 12 depicts a diagrammatic representation of a distributed network computing environment where embodiments disclosed can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

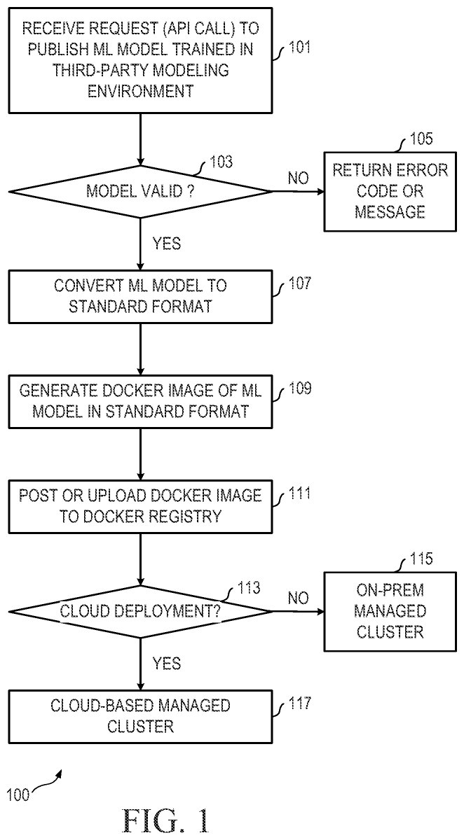

FIG. 1 is a flow chart that illustrates an example of a ML model publication method 100 according to some embodiments disclosed herein. In the example of FIG. 1, an MLMM system may receive, from a client device through an API of the MLMM system, a request to publish an analytics model (e.g., a ML model) that has been built, developed, and trained in a modeling environment (101). The MLMM system may operate to perform any necessary pre-processing on the request. For example, if the request contains a zip file or a compressed file, the MLMM system may extract the ML model from the zip file or decompress the compressed file.

In some embodiments, the MLMM system is operable to determine whether the ML model is valid (103). Various validation techniques may be utilized. For instance, the MLMM system may examine the ML model and determine whether the ML model is of a valid supported model type. The MLMM system may verify whether the ML model is packaged correctly based on the valid supported model type. For instance, for SKLEARN, the ML model should be packaged (e.g., in a zip file) with only a .PKL file. For SPARK MLlib and TENSORFLOW, the ML model should be packaged with multiple folders and files. Further, the MLMM system may determine whether the machine learning model is free of malware. The MLMM system may determine whether the machine learning model is packaged with any unwarranted file or system call. Where the machine learning model is packaged in a zip file, the MLMM system may validate the zip file name.

In some embodiments, application of these validation methods may vary from implementation to implementation, depending upon what is contained in the request (e.g., what kind of schema, what type of ML model, what file format is used to package the ML model, etc.). For example, a request to publish a ML model received by the MLMM system through an API call may contain a schema and a ML model package as input to the MLMM system. The ML model package can be a zip file or some other suitable archive or compressed file formats. The ML model package may contain a combination of folder(s) and/or file(s) or it may contain assets needed to host the ML model as a service.

For a JSON schema, the MLMM system may operate to check whether ML model is of a valid supported model type. A different check may be performed for a schema in the extensible markup language (XML). If the ML model is packaged in a zip file, the MLMM system may operate to check whether the zip file contains any unwarranted files. A different check may be performed if the ML model is packaged in a different archive file format. If the ML model was trained using SKLEARN, the MLMM system may operate to verify that there is no system call present in the .PKL file contained in the zip file and also validate the zip file name.

Depending upon whether the ML model is valid or invalid, the MLMM system may operate to convert the ML model to a standard format or generate a response indicating that the ML model is invalid For instance, if the ML model fails a validation check, the MLMM system may return an error code or a message, indicating that the ML model is invalid or that API call has failed (105). If the ML model is validated, the MLMM system may operate to convert the ML model to a normalized or standard ML model format such as MLflow (107).

MLflow comprises OSS for ML learning workflows commonly used by ML DevOps teams and data scientists and is organized into four main components: tracking, project, model, and model registry. ML DevOps refers to ML operations and encompasses people, processes, and platform for monitoring, validation, and governance of ML models. A ML model usually includes a sequence of steps. The model conversion saves this sequence of steps into the MLflow's model format. The MLMM system may then operate to generate a docker image of the ML model in the MLflow's model format using, for instance, a source-to-image toolkit called S2I (109).

As those skilled in the art can appreciate, a docker image is a read-only immutable template that defines how a container will be realized. At runtime, an instance of the docker image is generated to run as a containerized application. This instance is referred to as a docker container. The docker image can be stored.

Accordingly, the MLMM system may operate to post or upload the docker image to a docker registry (e.g., a container registry) (111). At this point, the ML model is considered as having been published and ready for deployment to a managed cluster.

In some embodiments, the MLMM system may operate to determine whether the published ML model is to be deployed to a cloud-based managed cluster (113). If so, the MLMM system may operate to deploy the docker image from the docker registry to a cloud-based managed cluster (117) such as a K8s cluster managed, for example, by a hyperscaler (e.g., a large-scale cloud computing platform). Otherwise, the MLMM system may operate to deploy the docker image from the docker registry to an on-prem managed cluster operating in an enterprise computing environment (115). The on-prem managed cluster may also be a K8s cluster.

In some embodiments, the MLMM system may receive a plurality of requests to publish ML models from disparate computing environments where the ML models were built, developed, and trained. These disparate computing environments can be owned and/or operated independently of one another. As discussed above, the MLMM system may operate to validate each of the ML models, convert validated ML models in disparate formats to a standard or normalized format, and generate a docker image for each of the validated ML models thus standardized or normalized. These docker images can then be posted to, or otherwise stored in, the docker registry. Now published, the docker images stored in the docker registry are ready for deployment to a managed cluster.

As alluded to above, with the API-based ML model publication disclosed herein, development/training of an ML model is decoupled from publication/deployment of the ML model. This separation allows the ML model to be built on any suitable platform using any suitable ML library and ML modeling application running in any suitable modeling environment.

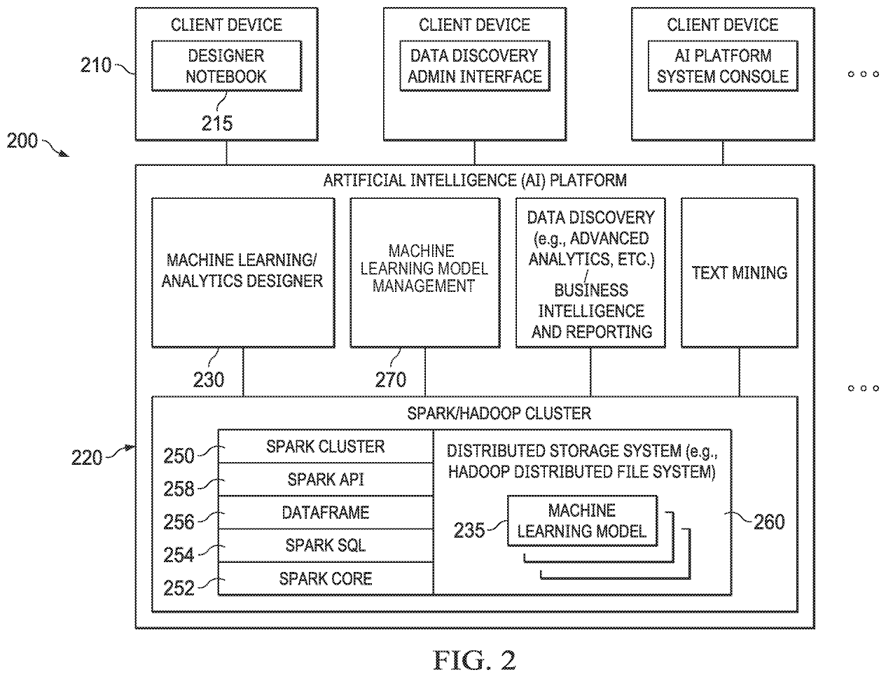

As a non-limiting example, FIG. 2 depicts an example of a network computing environment 200 where a ML modeling application (e.g., ML/Analytics Designer 230) is hosted on an artificial intelligence (AI) and analytics platform (e.g., AI platform 220). OpenText™ Magellan, available from Open Text headquartered in Waterloo, Canada, is an example of a flexible AI and analytics platform that combines ML, advanced analytics, and enterprise-grade business intelligence to acquire, merge, manage, and analyze large volumes (“big data”) of structured and unstructured data.

As illustrated in FIG. 2, ML/Analytics Designer 230 has a web-based interface or frontend application (e.g., Designer Notebook 215) that can be accessed by a user (e.g., an application developer, a ML model developer, a data scientist, etc.) on a user device (e.g., client device 210) over a network (which, although not shown in FIG. 2, can include the Internet and any appropriate private/public networks that enable the user device and the AI platform to communicate with each other). All or a portion of AI platform 220 can be hosted in a cloud computing environment.

In this case, Designer Notebook 215 functions as an interface to a modeling environment provided by ML/Analytics Designer 230 running on AI platform 220 for building, developing, training, and publishing ML models. As a non-limiting example, a data scientist may use the ML modeling application (which includes the web-based interface or frontend application running on the user device and the ML/analytics engine running on the AI platform) to build and train a ML model 235 through a SPARK-based ML pipeline as known to those skilled in the art. In this example, the SPARK-based ML pipeline is supported by a SPARK cluster 250 (which refers to a computing platform on which SPARK is installed). Structured data inside SPARK programs can be queried using SQL or SPARK API 258. SPARK ML API 258 uses Dataframe 256 from SPARK SQL 254, which is built on top of SPARK Core 252, as a ML dataset. This ML dataset holds a variety of data types (e.g., a Dataframe could have different columns storing text, feature vectors, true labels, and predictions). The ML model 235 thus trained is stored with a model name and in a specific folder in a Hadoop distributed file system (HDFS) 260, which is accessible by SPARK cluster 250.

In this way, a trained ML model can be published directly from a ML modeling application to a target computing system by providing the target computing system with a path to the repository location where the trained ML model is stored and with information on the attributes required by the ML model to run. An example of this ML model publication approach is described in U.S. Pat. No. 11,514,356, which is incorporated by reference herein.

In the example of FIG. 2, the publication of the ML model is seamlessly integrated with the development/training of the ML model. This seamless integration is possible because the ML modeling application, which provides the modeling environment, and a ML model publisher, which publishes ML models trained using the ML modeling application, are part of the same AI platform. This integration allows attributes required to run a published ML model to be captured while the ML model was in the modeling environment and also allows the ML model publisher to use the attributes thus captured to automatically fill out a schema definition section of a publication request form or page so that the ML model can be readily published directly from the ML modeling application. This API-based ML model publication approach provides one-to-many publishing of a ML model by providing, to each of a plurality of target computing systems, a path to the repository location where the ML model is stored and the information on the attributes required to run the ML model. However, this one-to-many ML model publication approach also means that ML models built, developed, and trained using ML modeling applications that are not on the same AI platform (which are referred to hereinafter as “third-party ML modeling applications”) cannot be published to any target computing systems supported by the AI platform.

According to some embodiments disclosed herein, publication of a ML model can be decoupled from the development/training of the ML model. In such scenarios, the ML modeling application discussed above with reference to FIG. 2 can be used for developing/training ML models only. Once an ML model is trained, the ML modeling application can make an API call to publish the trained ML model to an MLMM system as disclosed herein. This API-based ML model publication approach eliminates the need to install a ML model publisher plugin in Designer Notebook 215.

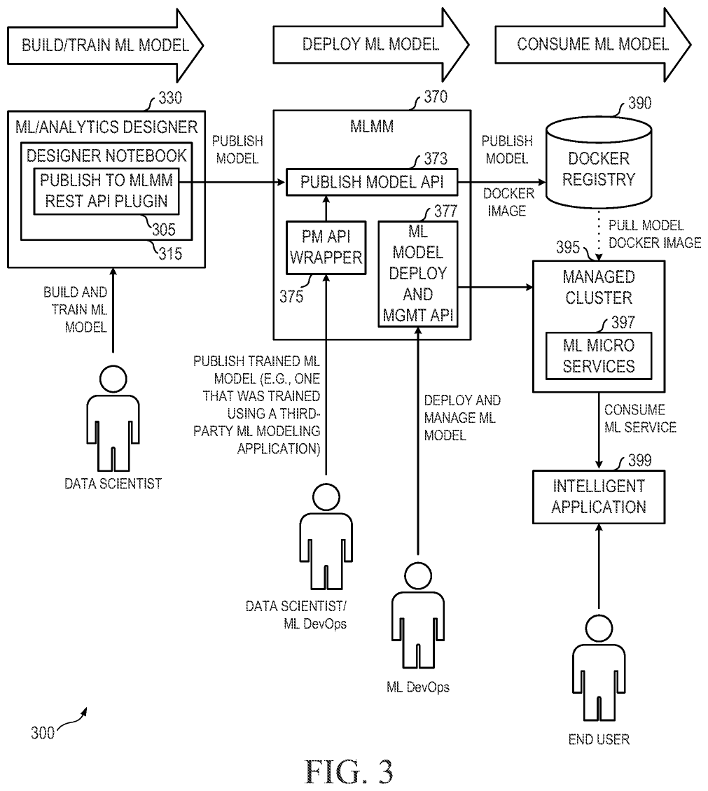

In some embodiments, the MLMM system can be part of a larger system. For instance, as shown in FIG. 2, AI platform 220 may include an MLMM system 270. However, the ML modeling application and the MLMM system can be functionally separate and distinct. This is illustrated in FIG. 3.

In the example of FIG. 3, a ML model can be built and trained by a data scientist using a native (as to an AI platform, such as AI platform 220) ML modeling application which includes ML/Analytics Designer 330 and Designer Notebook 315 configured for making a REST API call to publish the ML model to an MLMM system 370. The data scientist may have already signed into the AI platform through Designer Notebook 315. As discussed below, the REST client may obtain an authentication token from the AI platform (e.g., via OAUTH) and send the ML model with the authentication token via a REST API call to a ML model publication API of the MLMM system (e.g., the publish model API 373 of MLMM system 370 shown in FIG. 3). Because the ML model was built and trained using the native ML modeling application, the ML model may already be in a standard format (e.g., MLflow) used by the MLMM system. Further, the ML model may already be validated by the native ML modeling application. Accordingly, referring back to FIG. 1, in response to the REST API call to the ML model publication API, the MLMM system may proceed to generate a docker image of the ML model (109) and upload the docker image to a container registry (e.g., the docker registry 390) (111).

Referring again to FIG. 3, an authorized user (e.g., a member of ML DevOps permitted to access the MLMM system 370) may, through an AI platform system console running on a client device, such as one shown in FIG. 2, make an API call to a ML model deployment and management API 377. Responsive to the API call to the ML model deployment and management API 377, the MLMM system 370 may operate to pull the docker image from the docker registry 390 and deploy the ML model to a managed cluster 395 (e.g., by instantiating an instance of the docker image to run in the managed cluster). Here, the managed cluster 395 represents a target computing system or platform that is usually operated in an enterprise computing environment on the premises of an enterprise or in a cloud computing environment (e.g., as an enterprise tenant of a cloud service provider).

At runtime, the instance of the docker image runs as a containerized application (i.e., a docker container) that implements the ML model. In this example, the ML model runs in the container to provide an ML microservice 397 which, in turn, is consumed by an intelligent application 399. An end user may access the ML microservice 397 through an interface of the intelligent application 399 on a user device.

For a ML model that is built and trained by a data scientist or a member of ML DevOps using a third-party ML modeling application, a special API wrapper is provided (e.g., the publish model API wrapper 375).

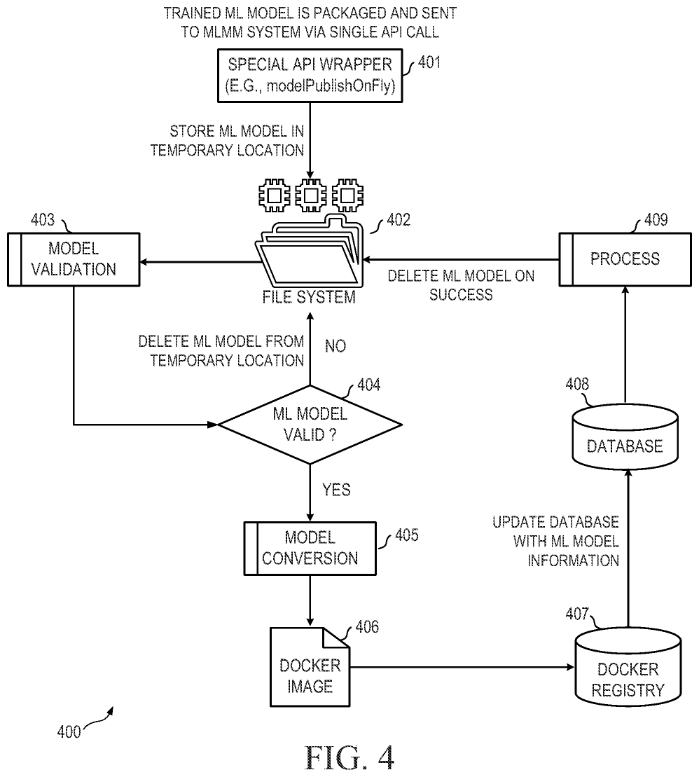

In this case, the data scientist or a member of ML DevOps may make an API call to the publish model API wrapper 375 with a ML model package (e.g., a zip file) containing a ML model trained using a third-party ML modeling application (i.e., one that is not native to the MLMM system or the AI platform). The API call may also include a ML model schema. In response, the publish model API wrapper 375 programmatically calls a set of APIs, including a model validation API (see, e.g., FIG. 4, model validation 403) to validate the third-party ML model (103) and a ML model conversion or normalization API (see, e.g., FIG. 4, model conversion 405) to convert or normalize the third-party ML model into a standard format (e.g., MLflow) that is native to or supported by the MLMM system (107). Finally, the publish model API wrapper 375 calls the publish model API 373. In response, the publish model API 373 performs the rest of the ML model publication as described above. That is, once the ML model is converted, normalized, or otherwise standardized into a common format used by the MLMM system, the MLMM system can generate a docker image for the ML model in the common format (109) and upload the docker image to the docker registry 390 (111) for deployment to the managed cluster 395.

In some embodiments, the special API wrapper (e.g., the publish model API wrapper 375) for the ML model publication API (e.g., the publish model API 373) may reside at a designated network address of a server running the MLMM system. As a non-limiting example, the publish model API wrapper 375 may reside at a universal resource locator (URL) within the MLMM system.

From the perspective of a data scientist or a ML model developer of an ML DevOps team using the third-party ML model application, a single API call is made to a particular URL (e.g., http://.../publish/modelPublishOnFly). Where necessary, the data scientist or the ML model developer may be prompted by the MLMM system to provide their authentication credentials.

Thereafter, the MLMM system can handle all the processing needs to publish the third-party trained ML model including, for instance, validating the third-party trained ML model, converting the third-party trained ML model to a standard format, generating a docker image from the ML model in the standard format, and uploading the docker image to a docker registry so that the ML model (in a containerized form) is ready to be stored in the docker registry for deployment.

The above-described API-based ML model publication allows the ML model publication API, which heretofore can only be called by a native ML modeling application (e.g., through a plugin embedded in the Designer Notebook 215), be called by any ML modeling applications, including third-party ML modeling applications.

Below is a non-limiting example of an HTTP request to a publish model API wrapper for the ML model publication API:
POST http://10.96.94.90:port#/publish/modelPublishOnFly

In some embodiments, the HTTP request can be made with file parameters such as “metadataJsonFile” (which references a schema file such as metadata.json) or “modelbundleFile” (which references a package or bundle such as a zip file containing a trained ML model).

FIG. 4 depicts a diagrammatic representation of an example of a ML model lifecycle 400 according to some embodiments disclosed herein. To illustrate the ML model lifecycle 400, as a non-limiting example, a data scientist or a ML model developer from an ML DevOps team may train a ML model in any open-source PYTHON-based notebook/JUPYTER notebook and save the ML model.

Depending upon the type of the ML model, this saving action may produce different outcomes. For example, for SKLEARN, saving the ML model would produce a pickle file (.PKL) containing the saved ML model. For SPARK MLlib, this action would produce a path to a location in the HDFS (e.g.,/.../HDFS/S3) where the ML model is stored. For TENSORFLOW, this action would produce a saved_model.pb file containing the saved ML model.

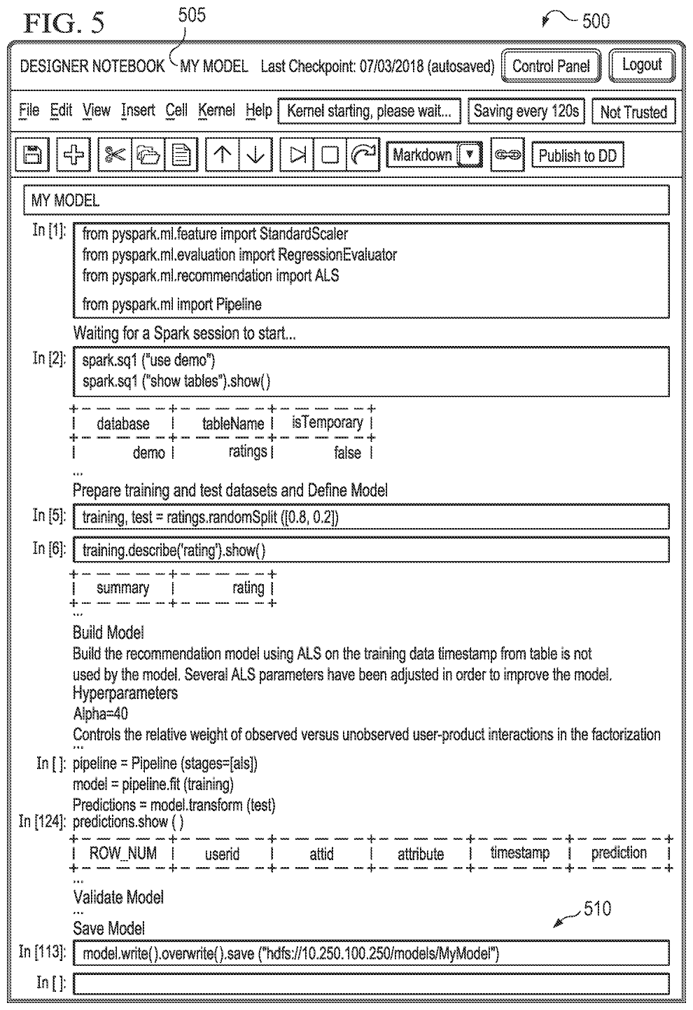

FIG. 5 is a diagrammatic representation of a user interface (UI) 500 for Designer Notebook. In this example, saving a ML model 505 would produce a path 510 to a repository location where the ML model 505 is stored in the HDFS.

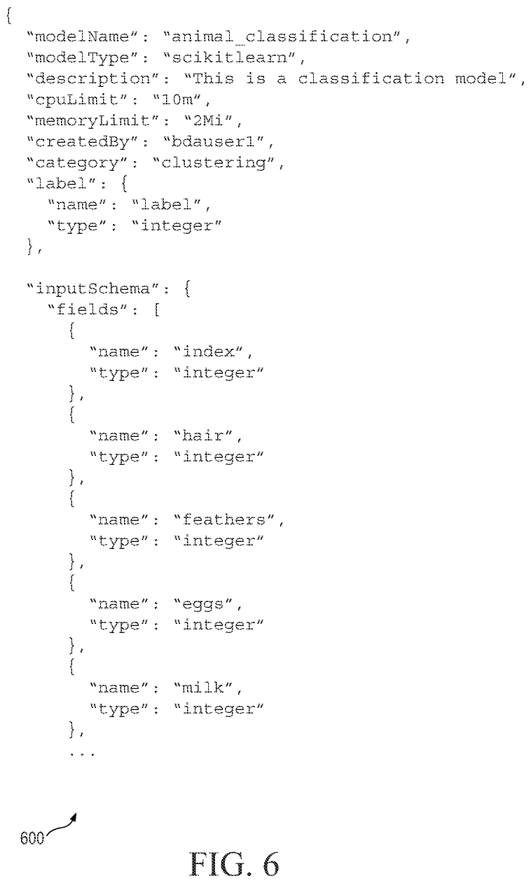

The ML model thus saved has an associated ML model schema. As a non-limiting example, the ML model schema can comprise a JSON file. As illustrated in FIG. 6, such a JSON file 600 can contain metadata about the ML model (e.g., an animal classifier).

Referring to FIG. 4, to prepare for publication, the ML model can be packaged and/or compressed (e.g., in a zip file). The zip file and the ML model's input schema are passed to a REST client to call the special API wrapper (e.g., modelPublishOnFly) (401).

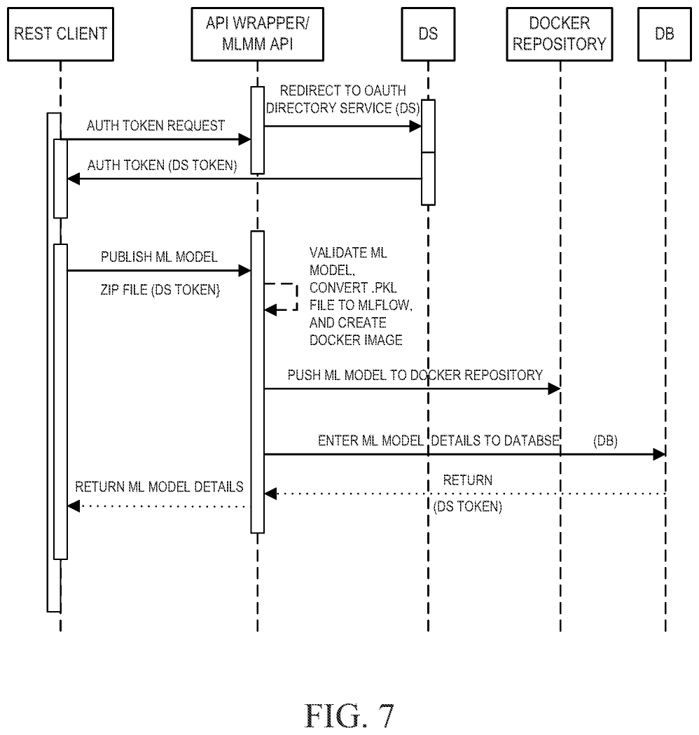

FIG. 7 is a sequence diagram that illustrates how the REST client may request an authorization token, which is passed to the MLMM API which, in turn, redirect the request to a directory service (DS) according to an authorization protocol (e.g., OAUTH) implemented by the MLMM API. The DS returns an authentication token to the requesting REST client which, in turn, sends a zip file with the authentication token.

In response, the MLMM system may operate to process the zip file, extract a ML model from the zip file, and store the ML model in a temporary location in a file system (402). The MLMM system may operate to validate the ML model (403) and make a determination based on a result of the validation (404). If the ML model is invalid, then the ML model (and any associated assets) is deleted from the temporary location in the file system. The ML model lifecycle ends.

If the ML model is valid, then a model conversion is performed on the ML model (405). The model conversion standardizes or normalizes the ML model into a common format (e.g., MLflow format) that can be used by the MLM system to generate a docker image using, for example, a S2I command (406). In some embodiments, the docker image thus generated may vary from implementation to implementation based on the model type (e.g., SKLEARN, SPARK, KERAS, etc.). The docker image is then posted, pushed, or uploaded to a docker registry (407).

In some embodiments, once the docker image is posted, pushed, or uploaded to the docker registry, an insert statement is created and added to a database maintained by the MLMM system (408). In some embodiments, a UI of the MLMM system may correspondingly be updated to show the current status of the ML model.

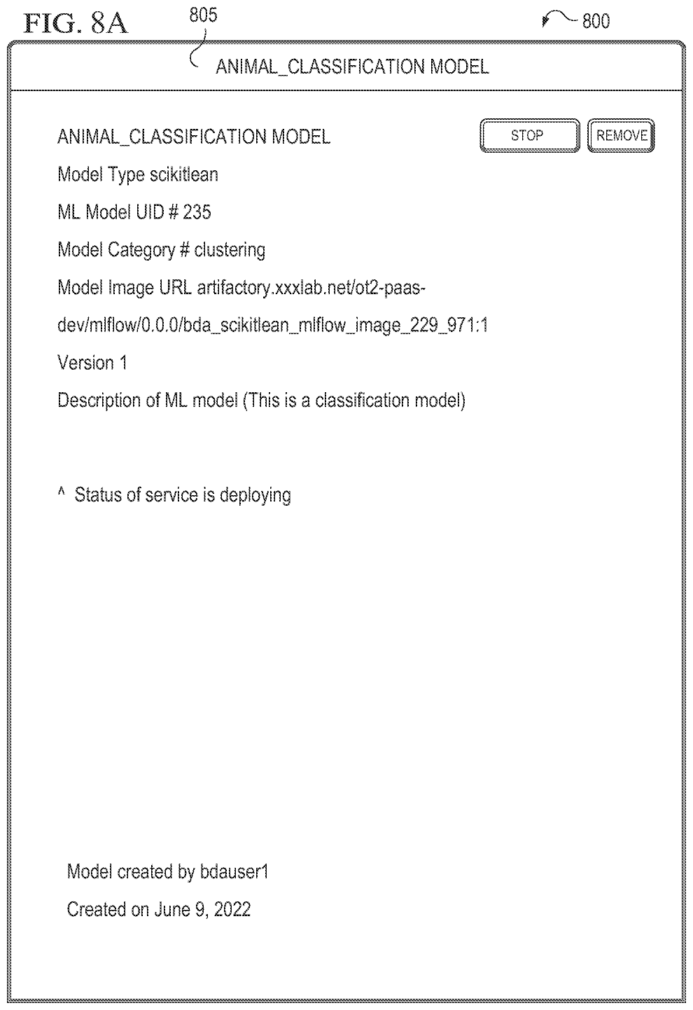

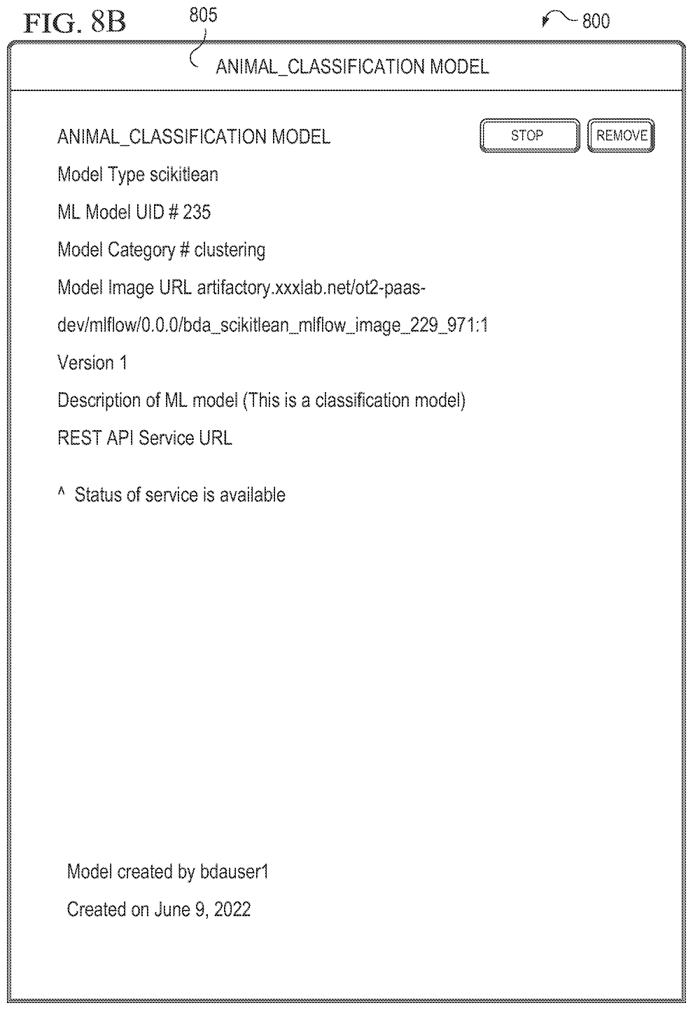

FIG. 8A depicts a diagrammatic representation of an example MLMM UI 800 before deployment of a ML model 805 according to some embodiments disclosed herein. For instance, the MLMM UI may show the newly published ML model with a “not in production” status. If the ML model 805 is in the process of being deployed, the MLMM UI 800 may be updated to indicate that the status of a corresponding ML service is “deploying.” UI updating can occur on the fly while the ML model is being published and/or deployed.

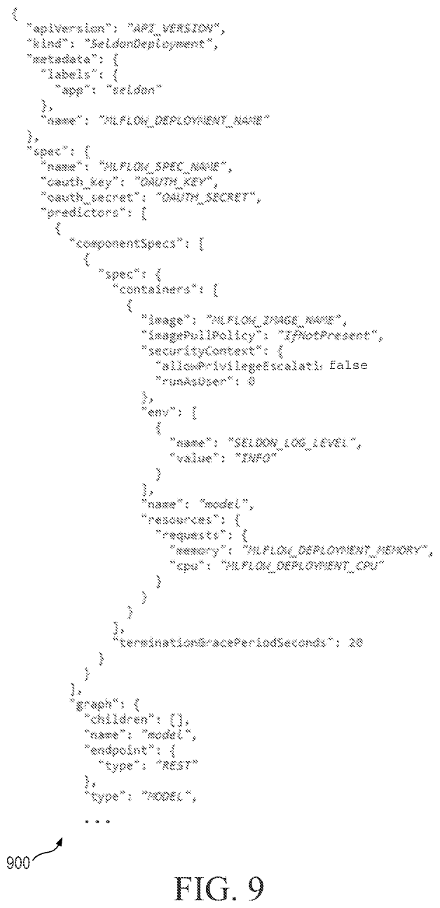

In some embodiments, the MLMM system may update an internal MLMM document with the image name, deployment type_oauth_key, oauth_secret, etc. and proceed with the deployment into a K8s cluster. A portion of an MLMM document 900 is shown in FIG. 9. Below is a non-limiting example of a command to deploy to a K8s cluster:
default-commands.kubectl.deployment.create=kubectl create-f % destPath%--namespace=seldon-system

After the ML model is successfully deployed, a post-deployment cleanup process may be initiated to delete the ML model from the temporary location in the file system (409). This ends the ML model lifecycle 400. In some embodiments, the UI of the MLMM system may correspondingly be updated to show the status of a ML service provided by the deployed ML model as “available.”

FIG. 8B depicts a diagrammatic representation of the MLMM UI 800 after deployment of the ML model 805 according to some embodiments disclosed herein. In this example, the ML model 805 has a model name “animal_classification” and a unique ID (UID) “235” and may be deployed to a network address containing the model name and the UID.

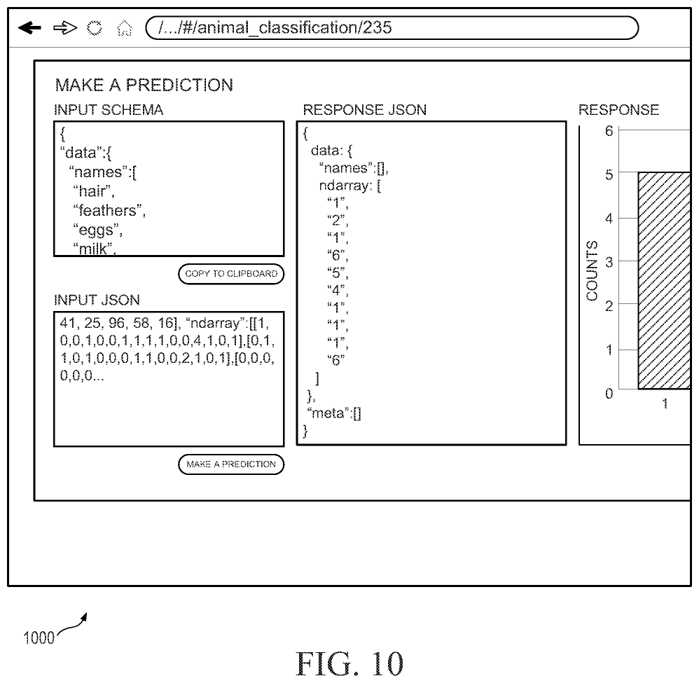

As a non-limiting example, FIG. 10 depicts a user interface of an intelligent application 1000 through which the ML model 805 can be called to get a prediction such as a classification.

In some embodiments, the API-based ML model publication approach described above can support column-based ML models trained by supervised learning. In some embodiments, the API-based ML model publication approach described above can also support ML models trained using semi-supervised learning and/or unsupervised learning such as those for image classification.

Further, with the API-based ML model publication approach described above, there is no need to install a plugin to a ML modeling application. To publish a trained ML model, a ML modeler (e.g., a data scientist, a member of an ML DevOps team, etc.) can make a single API call with a zip file (or any package or archive format supported by the MLMM system). In response, the MLMM system will programmatically automatically handle the rest of the publication process. The MLMM system is enhanced with the ability to standardize disparate ML model formats into a common format for subsequent docker image generation. The validation process is also enhanced with the ability to process ML models from third-party ML modeling applications.

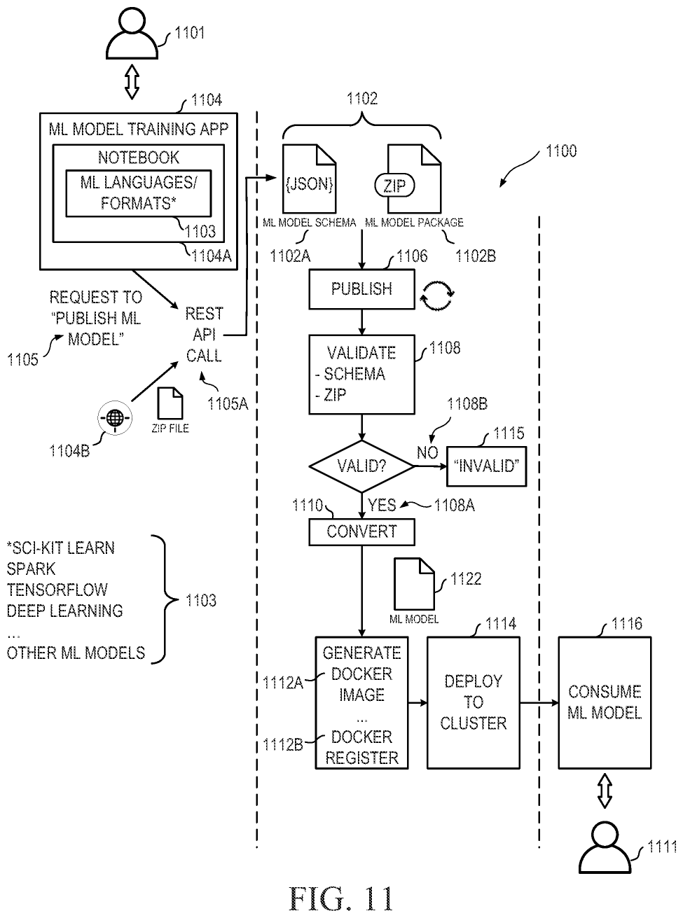

The inventive subject matter, in some embodiments, is directed to architectures, methodologies, and techniques for format-agnostic publication of a model machine learning model. Referring now to FIG. 11, a system 1100 for format-agnostic publication of a machine learning model 1102 comprises a processor, a non-transitory computer-readable medium, and stored instructions translatable by the processor for executing a system 1100 that receives a request to publish 1105 a ML model 1102.

In this example, the request to publish 1105 comprises a ML model schema 1102A and a ML model package 1102B. In one embodiment, the ML model package 1102B comprises one or more files and one or more file directories.

The ML model schema 1102A is generated and sent in the request to publish 1105 the ML model 1102. The schema 1102A may include a matrix of entities and variable values for the entities, each row of cells of the matrix denoting a value for an entity's variable.

In a non-limiting example, the variables can include those to describe animals such as whether an animal has hair, feathers, produces eggs, produces milk, is air-born, is aquatic, etc. Each row of the matrix will include an instance of an animal with the values of the variables across the columns.

In further embodiments, the schema 1102A comprises an identification of the format or language of the ML model 1102. For example, the schema 1102A may name one of many possible ML languages (generally designated by reference numeral 1103), including, but not limited to, SKLEARN (a ML library in the Python programming language), Spark by Apache® (a multi-language engine for executing data engineering, data science, and ML on single-node machines or clusters), TensorFlow (an open-source platform for machine learning), and/or a deep learning model language, and other ML model languages. In still further embodiments, the schema 1102A comprises metadata in the JSON format (JSON is a lightweight format for storing and transmitting data). An advantage of the JSON format is that it is human-readable, thereby facilitating viewing and editing of the schema 1102A. In yet other embodiments, other schema formats are possible, such as XML.

The ML model package 1102B, like the schema 1102A, is generated and sent in the request to publish 1105 the ML model 1102. In some embodiments, the ML model package 1102B is compressed to enhance data transmission and minimize package size. As stated above, the package comprises one or more files and one or more file directories which specify the ML model 1102. In further embodiments, the package 1102B is a Zip file, which is a compressed format comprising files and file directories. In yet other embodiments, the package 1102B is an archive of data, such as files and directories.

In some embodiments of system 1100, the request to publish 1105 the ML model 1102 is received from a ML model training application 1104 and, publication of the ML model 1102 is agnostic of the format of the ML model 1102 (as shown, once again, by the list of ML model formats and languages, generally designated by reference numeral 1103). One of ordinary skill in the art will recognize that Data Scientists 1101 typically build and train ML models using a Notebook 1104A.

There are a variety of existing proprietary and open-source Notebooks, each typically designed to build and train models in specific ML modeling formats and languages. Advantageously, Data Scientists 1101 can leverage system 1100 to issue a request to publish a ML model (for example, ML model 1102) using any Notebook, as long as the request to publish comprises a ML model schema and a ML model package for the model. Such a format-agnostic, publish-on-the-fly system 1100 for publishing a ML model has many advantages, including the flexibility to build and train models using any Notebook and in a variety of languages to publish the model for consumption without regard to the type of proprietary and/or open-source tools.

In still other embodiments, the request to publish 1105 is an application programming interface call 1105A (API call). Such an API call 1105A may include a Representation State Transfer (REST) API call (also referred to as a RESTful API call) to system 1100. A REST API call may be received from training application 1104 described above or from any program or service (generally designated by reference numeral 1104B) capable of generating a RESTful API call.

As described above, system 1100 publishes 1106 the ML model 1102 based on the ML model schema 1102A and the ML model package 1102B, received as input by system 1100. Because this input is received from outside system 1100 and must comply with the necessary input components (i.e., the schema 1102A and the package 1102B) system 1100 validates 1108 the request to publish 1105. This comprises validating the ML model schema 1102A and the ML model package 1102B. In some embodiments, system 1100 validates 1108 that the schema 1102A includes an identification of a ML model language.

More generally, system 1100 may validate that the package 1102B is free of malware and/or that package 1102B does not contain any unexpected files or data. System 1100 may more specifically validate 1108 that (when the expected package is in the Zip file format) the package 1102B comprises the expected files and/or directories. In non-limiting examples, if the identified language in schema 1102A is SKLEARN, then system 1100 validates that the Zip file contains a file in the Pickle (a way to serialize objects, stored as a “.pkl” file) format, and for other identified formats, that the Zip file includes files and file directories.

If the request to publish 1105 is valid (at 1108A), system 1100 converts (at 1110) the ML model 1102 into a common ML model format 1122. System 1100 may then generate a Docker image 1112A for the converted model 1122 and register it in a Docker registry 1112B. The model may then be deployed 1114, such as to a cluster (such as, but not limited to, a Kubernetes cluster (Kubernetes is an open-source container orchestration system for automating software deployment, scaling, and management)) so that the model may be consumed 1116, such as by a user 1111 or an external system.

If the request to publish 1105 the ML model 1102 is invalid (at 1108B), system 1100 may forgo converting the model 1102 and issue a response or message 1115 that the ML model 1102, the schema 1102A, and/or the package 1102B is invalid, such as a response to the training application 1104 (e.g., Notebook 1104A) or to program or service 1104B that issued the API call 1105A to publish the model 1102.

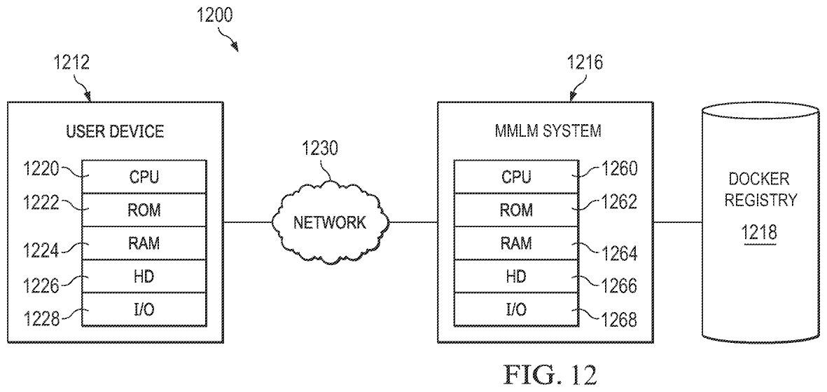

FIG. 12 depicts a diagrammatic representation of a distributed network computing environment where embodiments disclosed can be implemented. In the example of FIG. 12, network computing environment 1200 may include network 1230 that can be bi-directionally coupled to user computer 1212 and MLMM system 1216 which, in this example, has access to docker registry 1218. Network 1230 may represent a combination of wired and wireless networks that network computing environment 1200 may utilize for various types of network communications known to those skilled in the art.

For the purpose of illustration, a single system is shown for each of user computer 1212 and MLMM system 1216. However, within each of user computer 1212 and MLMM system 1216, a plurality of computers (not shown) may be interconnected to each other over network 1230. For example, a plurality of user computers may be communicatively connected over network 1230 to one or more servers on which MLMM system 1216 runs.

User computers 1212 may include a data processing system for communicating with MLMM system 1216. User computer 1212 can include central processing unit (“CPU”) 1220, read-only memory (“ROM”) 1222, random access memory (“RAM”) 1224, hard drive (“HD”) or storage memory 1226, and input/output device(s) (“I/O”) 1228. I/O 1228 can include a keyboard, monitor, printer, electronic pointing device (e.g., mouse, trackball, stylus, etc.), or the like. User computer 1212 can include a desktop computer, a laptop computer, a personal digital assistant, a cellular phone, or nearly any device capable of communicating over a network. AI platform server 1216 may include CPU 1260, ROM 1262, RAM 1264, HD 1266, and I/O 1268. Many other alternative configurations are possible and known to skilled artisans.

Each of the computers in FIG. 12 may have more than one CPU, ROM, RAM, HD, I/O, or other hardware components. For the sake of brevity, each computer is illustrated as having one of each of the hardware components, even if more than one is used. Each of computers 1212 and 1216 is an example of a data processing system. ROM 1222 and 1262; RAM 1224 and 1264; HD 1226 and 1266; and data store 1218 can include media that can be read by CPU 1220 and/or 1260. Therefore, these types of memories include non-transitory computer-readable storage media. These memories may be internal or external to computers 1212 or 1216.

Portions of the methods described herein may be implemented in suitable software code that may reside within ROM 1222 or 1262; RAM 1224 or 1264; or HD 1226 or 1266. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively or additionally, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HyperText Markup Language (HTML), Python, or any other programming or scripting code. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms “comprises,” “comprising,” “includes, ” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. The scope of the present disclosure should be determined by the following claims and their legal equivalents.

What is claimed is:

1. A system for format-agnostic publishing of a machine learning model, comprising:
a processor;
a non-transitory computer-readable medium; and
stored instructions translatable by the processor for executing:
receiving a request to publish a machine learning model, the request comprising a machine learning model schema and a machine learning model package comprising one or more files;
publishing the machine learning model based on the machine learning model schema and the machine learning model package, comprising:
validating the machine learning model schema and the machine learning model package to determine whether the request to publish the machine learning model is valid;
wherein, if the request to publish the machine learning model is valid, converting the machine learning model to a common machine learning model format and deploying the converted machine learning model; and
if the request to publish the machine learning model is invalid, generating a response that the request to publish the machine learning model is invalid.

2. The system of claim 1, wherein the request to publish the machine learning model is received from a machine learning model training application, the machine learning model schema comprising an identification of a machine learning model format, wherein:
publishing of the machine learning model is agnostic of the identification of the machine learning model format of the machine learning model.

3. The system of claim 1, wherein the machine learning model schema comprises an identification of a machine learning model format of the machine learning model.

4. The system of claim 3, wherein the machine learning model schema comprises metadata in a JavaScript Object Notation (JSON) format.

5. The system of claim 1, wherein the machine learning model package is compressed.

6. The system of claim 5, wherein the machine learning model package is a zip file.

7. The system of claim 1, wherein validating the machine learning model package comprises at least one of: validating that the package is free of malware or, validating that the package comprises at least one file and at least one file directory.

8. A method for format-agnostic publishing of a machine learning model, comprising:
receiving a request to publish a machine learning model, the request comprising a machine learning model schema and a machine learning model package comprising one or more files;
publishing the machine learning model based on the machine learning model schema and the machine learning model package, comprising:
validating the machine learning model schema and the machine learning model package to determine whether the request to publish the machine learning model is valid;
wherein, if the request to publish the machine learning model is valid, converting the machine learning model to a common machine learning model format and deploying the converted machine learning model; and
if the request to publish the machine learning model is invalid, generating a response that the request to publish the machine learning model is invalid.

9. The method of claim 8, wherein the request to publish the machine learning model is received from a machine learning model training application, the machine learning model schema comprising an identification of a machine learning model format, wherein:
publishing of the machine learning model is agnostic of the identification of the machine learning model format of the machine learning model.

10. The method of claim 8, wherein the machine learning model schema comprises an identification of a machine learning model format of the machine learning model.

11. The method of claim 10, wherein the machine learning model schema comprises metadata in a JavaScript Object Notation (JSON) format.

12. The method of claim 8, wherein the machine learning model package is compressed.

13. The method of claim 12, wherein the machine learning model package is a zip file

14. The method of claim 8, wherein validating the machine learning model package comprises at least one of: validating that the package is free of malware or, validating that the package comprises at least one file and at least one file directory.

15. A computer programming product comprising a non-transitory computer-readable medium storing instructions for format-agnostic publishing of a machine learning model, the instructions translatable by a processor for:
receiving a request to publish a machine learning model, the request comprising a machine learning model schema and a machine learning model package comprising one or more files;
publishing the machine learning model based on the machine learning model schema and the machine learning model package, comprising:
validating the machine learning model schema and the machine learning model package to determine whether the request to publish the machine learning model is valid;
wherein, if the request to publish the machine learning model is valid, converting the machine learning model to a common machine learning model format and deploying the converted machine learning model; and
if the request to publish the machine learning model is invalid, generating a response that the request to publish the machine learning model is invalid.

16. The computer programming product of claim 15, wherein the request to publish the machine learning model is received from a machine learning model training application, the machine learning model schema comprising an identification of a machine learning model format, wherein:
publishing of the machine learning model is agnostic of the identification of the machine learning model format of the machine learning model.

17. The computer programming product of claim 15, wherein the machine learning model schema comprises an identification of a machine learning model format of the machine learning model.

18. The computer programming product of claim 17, wherein the machine learning model schema comprises metadata in a JavaScript Object Notation (JSON) format.

19. The computer programming product of claim 15, wherein the machine learning model package is a compressed Zip file.

20. The computer programming product of claim 15, wherein validating the machine learning model package comprises at least one of: validating that the package is free of malware or, validating that the package comprises at least one file and at least one file directory.
